(19) United States
(12) Patent Application Publication
(10) Pub. No.: US 2026/0125863 A1
(43) Pub. Date: May 7, 2026

(54) ENERGY-ABSORBING STRUCTURES AND METHODS OF MAKING

(71) Applicant: Purdue Research Foundation, West Lafayette, IN (US)

(72) Inventors: Pablo D. Zavattieri, West Lafayette, IN (US); Yu Wang, Lafayette, IN (US); Jeffrey Paul Youngblood, Crawfordsville, IN (US); Jan Olek, West Lafayette, IN (US)

(21) Appl. No.: 19/375,861

(22) Filed: Oct. 31, 2025

Related U.S. Application Data
(60) Provisional application No. 63/715,121, filed on Nov. 1, 2024.

(51) Int. Cl. E01F 15/08; B28B 1/00; B33Y 10/00; B33Y 80/00

(52) U.S. Cl. CPC E01F 15/083; B28B 1/001; B33Y 10/00; B33Y 80/00

(57) ABSTRACT

Energy-absorbing structures and methods of making the same. Such an energy-absorbing structure, for example, a roadside barrier, has a main body formed by a laminar matrix having layers of filaments that emulate biological architectures, as nonlimiting examples, Bouligand (helicoidal) architectures and sinusoidal helicoidal architectures, in which rows of filaments in one layer are angularly offset at a pitch angle relative to the rows of filaments in the next layer. The main body of a roadside barrier incorporating such energy-absorbing material may be made of a concrete-based material and be formed by an additive manufacturing process, such as a three-dimensional concrete printing process.

### CROSS-REFERENCE TO RELATED APPLICATIONS

This application claims the benefit of provisional U.S. Patent Application No. 63/715,121 filed Nov. 1, 2024, the contents of which are incorporated herein by reference.

### STATEMENT REGARDING FEDERALLY SPONSORED RESEARCH

This invention was made with government support under grant No. 69A3552348333 awarded by the Department of Transportation. The government has certain rights in the invention.

### BACKGROUND OF THE INVENTION

The invention generally relates to energy-absorbing roadside barriers and methods of making the same.

Roadside barriers are placed along roads and similar areas of automotive and other vehicular traffic to prevent or reduce the risk of a vehicle accidentally leaving the traffic area, such as during a crash or by running off a road. Roadside barriers, therefore, serve important functions that include withstanding impact loads to stop or redirect a vehicle, and dissipating energy during vehicle impact to reduce the risk of injury to drivers and passengers of the vehicle.

Roadside barriers can be categorized as flexible, semi-rigid, or rigid, depending on their deflection characteristics resulting from an impact. Flexible and semi-rigid systems are generally more forgiving since much of the impact energy is dissipated by the deflection of the barrier, thereby imposing lower impact forces on the vehicle. Typical flexible and semi-rigid roadside barriers include cable barriers, W-beam barriers, timber guardrails, and box beam barriers, for example. FIG. 1 shows a conventional semi-rigid roadside barrier system including a horizontal W-beam guardrail hung from vertical wooden posts along the side of a roadway. Though widely used, flexible and semi-rigid systems can lack the strength to withstand high-impact loads from high-speed vehicles and large trucks.

Traditionally, rigid concrete barriers are favored over flexible alternatives in situations where high impact loads are likely due to the capacity of a rigid concrete barrier to withstand such forces. Typical rigid roadside barriers include reinforced concrete and masonry barriers. FIG. 2 shows a conventional steel reinforced cast concrete roadside barrier used as a median barrier between two opposing directional lanes of traffic. A drawback of traditional rigid concrete barriers is their lack of offering sufficient energy dissipation to reduce damage to a vehicle during an impact, which can increase the risk of vehicle damage and vehicle rollovers.

In view of the above, it would be desirable if various structures at risk of having to withstand and/or absorb high impact energies, such as impact barriers, roadside barriers, and other types of protective structures, were available that were capable of withstanding high impact loads while also being sufficiently flexible to reduce the risk of damage by dissipating impact energy.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, energy-absorbing structures and methods of fabricating energy-absorbing structures.

According to a nonlimiting aspect, an energy-absorbing structure includes a body having a laminar matrix with a plurality of layers. Each layer of the plurality of layers has a plurality of filaments. The plurality of filaments of each layer is oriented so that axes of individual filaments within each layer are substantially parallel to each other and the plurality of filaments in a first layer of the plurality of layers are oriented in a different direction than the plurality of filaments in a second layer of the plurality of layers that is adjacent to the first layer. The filaments in the first and second layers may be, for example, arranged to define a Bouligand (helicoidal) architecture and/or a sinusoidal helicoidal architecture.

According to another nonlimiting aspect, a method of fabricating an energy-absorbing structure includes forming the structure by additive manufacturing of a curable material when in a liquefied state to form a body that has a laminar matrix having a plurality of layers. Each layer of the plurality of layers includes a plurality of filaments. The plurality of filaments of each layer is oriented so that axes of individual filaments within each layer are substantially parallel to each other and the plurality of filaments in a first layer of the plurality of layers are oriented in a different direction than the plurality of filaments in a second layer of the plurality of layers that is adjacent to the first layer. The filaments in the first and second layers may be, for example, arranged to define a Bouligand (helicoidal) architecture and/or a sinusoidal helicoidal architecture.

The laminar matrix may be made of and/or include various types of curable materials suitable for additive manufacturing, such as 3D printing. In some configurations, the laminar matrix is concrete or another type of curable material.

The energy-absorbing structures described herein may take any of various different forms and may be particularly well suited for implementation into structures that need to absorb impacts. For example, such an energy-absorbing structure may be a roadside barrier or another type of structure that poses or is subject to potentially high risks from impacts.

Technical aspects of energy-absorbing roadside barriers and methods as described above preferably include the ability to withstand high impact loads while being sufficiently flexible to dissipate impact energy and/or provide a cost effective and lightweight semi-rigid system.

These and other aspects, arrangements, features, and/or technical effects will become apparent upon detailed inspection of the figures and the following description.

### BRIEF DESCRIPTION OF THE DRAWINGS

FIG. 1 is a perspective view of a conventional semi-rigid roadside impact barrier installed along the edge of a roadway.

FIG. 2 is a perspective view of a conventional rigid roadside impact barrier installed along a roadway between two lanes of oncoming lanes of traffic.

FIG. 3 is a perspective view of a roadside impact barrier according to an embodiment of the invention and depicts the barrier as having a body made of an energy-absorbing laminar matrix with sinusoidal helicoidal architecture shown in an enlarged view of a portion of the matrix of the barrier.

FIG. 4 is a perspective view of a roadside impact barrier according to another embodiment of the invention and depicts the barrier as having a body made of an energy-absorbing laminar matrix with a Bouligand (helicoidal) architecture shown in an enlarged view of a portion of the matrix of the barrier.

FIG. 5 is a diagrammatic illustration of two adjacent layers of concrete filaments having a sinusoidal helicoidal architecture, such as shown in FIG. 3.

FIG. 6 is a diagrammatic illustration of two adjacent layers of concrete filaments having a Bouligand architecture, such as shown in FIG. 4.

FIG. 7 represents results of compressive strength tests performed on cast concrete samples and three-dimensionally (3D) printed (3DP) concrete samples having a regular architecture.

FIGS. 8A and 8B represent results of, respectively, compressive strength and work of failure (WOF) comparisons between cast concrete samples and 3DP concrete samples that have various different architectures.

FIG. 9 is an Ashby plot of work of failure versus compressive strength for the samples represented in the data of FIGS. 8A and 8B.

FIGS. 10A and 10B represent results of peak impact load versus deflection of cast concrete samples and 3DP concrete samples at different impact loads.

FIGS. 11A and 11B are Ashby plots of peak impact load versus total energy absorption of cast concrete samples and 3DP concrete samples at different impact loads.

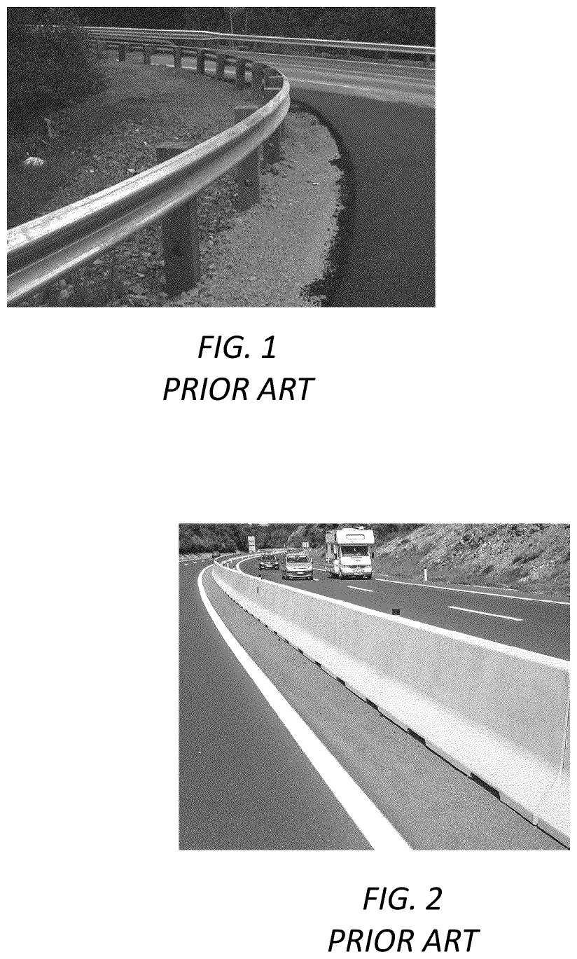

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s) to which the drawings relate. The following detailed description also describes certain investigations relating to the embodiment(s), and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

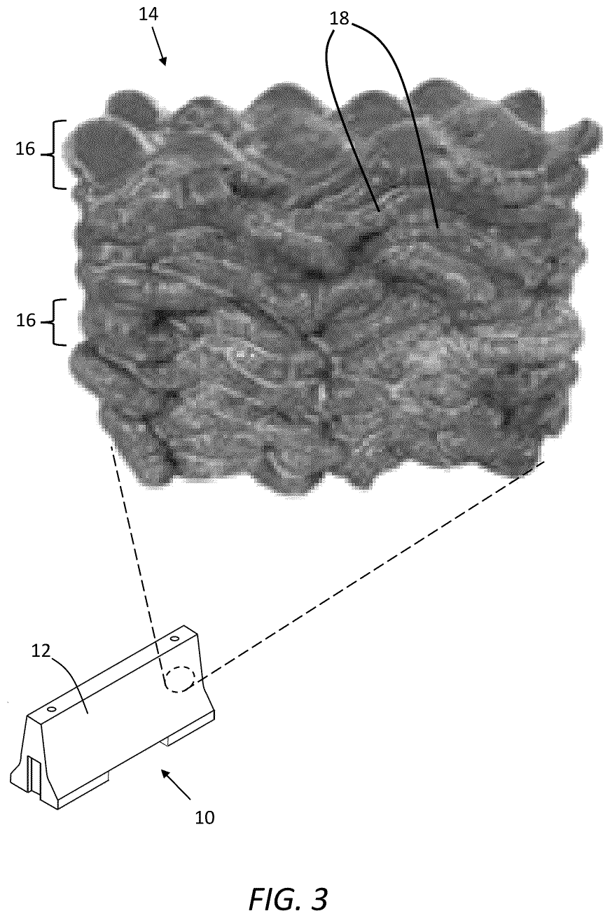

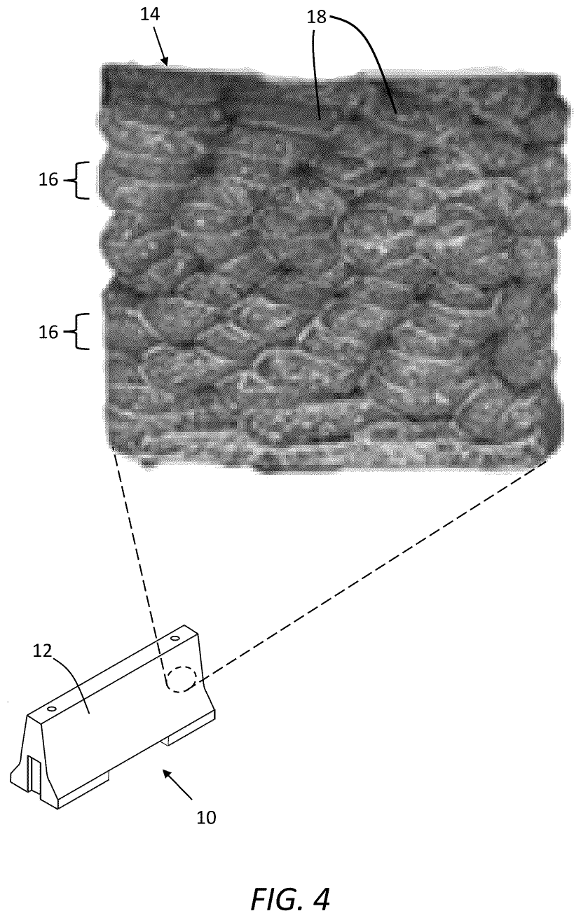

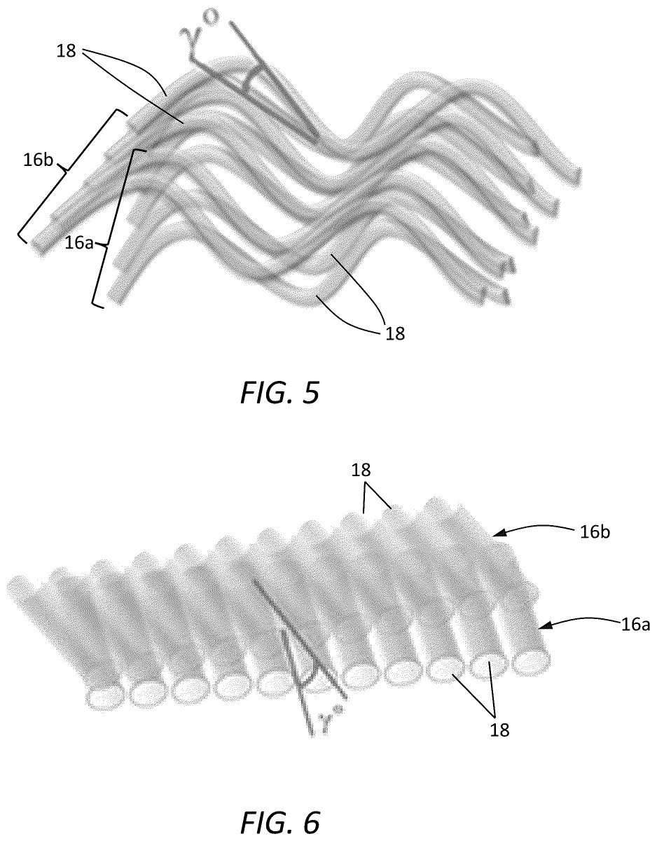

The following disclosure describes various aspects of energy-absorbing laminar matrices, which may be made of a curable material such as concrete, energy-absorbing structures made with the energy-absorbing laminar matrices, and methods related thereto. As nonlimiting examples, such energy-absorbing structures may be energy-absorbing roadside impact barriers (also called, simply, “roadside barriers” herein) described herein, including but not limited to exemplary roadside impact barriers 10 represented in FIGS. 3 and 4. Many different types of energy-absorbing structures may be made of or constructed with the energy-absorbing laminar matrices, a few nonlimiting examples of which are detailed herein. The roadside barriers 10 are made with an energy-absorbing concrete matrix 14, although other materials may be used for forming the matrix 14. Because of the energy-absorbing concrete matrix 14, the roadside barriers are preferably capable of exhibiting enhanced energy absorption capacities by leveraging certain architectures, such Bouligand (helicoidal) architectures and sinusoidal helicoidal architectures, and advanced 3D concrete printing (3DCP) technologies that are capable of incorporating and aligning filaments in a layer-by-layer printing process, such as represented in FIGS. 5 and 6. A nonlimiting example of a bio-inspired architecture is the dactyl club of a mantis shrimp that is known for its remarkable impact resistance and energy dissipation capabilities. Such bio-inspired Bouligand and sinusoidal helicoidal architectures are intended to induce crack twisting and spread damage through controlled damage propagation, thereby significantly enhancing the energy absorption and impact resistance of the barriers and resulting in improved mechanical performance relative to conventional rigid roadside barriers. Bio-inspired architectures and 3DCP technologies are preferably combinable to yield roadside barriers that can withstand high impact loads while being sufficiently flexible to dissipate impact energy more effectively than conventional concrete barriers, thereby improving their ability to protect drivers and passengers during roadside impacts. Experimental evaluations demonstrated that 3D-printed Bouligand and sinusoidal helicoidal architectures were capable of exhibiting enhanced flexural and compressive strengths compared to conventional cast concrete, and such characteristics were believed to be attributable to anisotropic properties induced by the layered printing process and filament alignment. Though Bouligand and sinusoidal helicoidal architectures are represented in FIGS. 3 through 6, it is possible that other architectures that mimic natural structures, such as honeycombs or shells, could be used. Furthermore, these architectures and the barriers 10 formed therefrom may incorporate various features, such as drainage channels or embedded sensors. In addition, the various descriptions of the energy-absorbing concrete matrices 14 used in the roadside barriers 10 and related manufacturing methods are also applicable to other types of structures and applicable to energy-absorbing matrices made of materials other than concrete.

Each of the energy-absorbing roadside barriers 10 depicted in FIGS. 3 and 4 has a body 12 with a shape and size intended to prevent or at least reduce the risk of a vehicle from improperly traveling off of the roadway. As used herein, the term “roadway” encompasses paved roads, streets, and highways, as well as any area where vehicular traffic may travel, such as parking lots, or any other paved or unpaved surfaces where vehicles may travel. In this example, the body 12 of each barrier 10 is in the form of a pre-manufactured modular roadside barrier section having a length that enables each barrier 10 to be used individually or in combination with multiple barriers arranged end to end to form a longer barrier wall extending along a roadway. The barriers 10 can be manufactured to have lengths and shapes other than those shown in FIGS. 3 and 4.

As best seen in the enlarged portions of FIGS. 3 and 4, the body 12 of each barrier 10 is formed of a laminar matrix 14 made up of a plurality of individual layers 16 (only two of which are labeled) of a matrix material, with layers 16 being stacked one on top of the other. As schematically represented in FIGS. 5 and 6, each individual layer 16 (individually labeled as 16a and 16b) is formed of a plurality of individual filaments 18 of the matrix material disposed in a two-dimensional array adjacent to each other. For purposes of illustration, FIGS. 5 and 6 show only two such layers 16a and 16b of the filaments 18, though the bodies 12 of the barriers 10 can contain any number of layers 16 stacked one on top of the other to form a body 12 of essentially any practicable size and shape. Also for purposes of illustration, FIGS. 5 and 6 show the filaments 18 within each individual layer 16a and 16b as not touching each other, though from FIGS. 3 and 4 and the following discussion is understood that contact between adjacent filaments 18 within a layer 16 preferably occurs and may be continuous along their lengths. Within each individual layer 16a and 16b, the filaments 18 may be straight or sinusoidal (undulating curved) segments whose axes can be generally described as parallel in that the filaments 18 within an individual layer 16 do not cross or intersect each other, though the filaments 18 themselves may touch each other along their lengths. In the embodiment of FIGS. 3 and 5, the filaments 18 are arranged to form a matrix having a sinusoidal helicoidal architecture, in which each filament 18 in a given layer 16 has a generally sinusoidal shape and the orientation of the filaments 18 in one layer (e.g., 16a in FIG. 5) is angularly offset by a pitch angle γ relative to the filaments 18 in the adjacent layer (e.g., 16b in FIG. 5). In the embodiment of FIGS. 4 and 6, the filaments 18 are arranged to form a matrix having a Bouligand (helicoidal) architecture, in which each filament 18 in a given layer 16 has a generally straight shape and the orientation of the filaments 18 in one layer (e.g. 16a in FIG. 6) is angularly offset by a pitch angle γ relative to the filaments 18 in the adjacent layer (e.g., 16b in FIG. 6). The pitch angles γ are preferably about 1° to about 30°, and more preferably about 5° to about 10°, though other pitch angles are foreseeable.

The laminar matrix 14 of the barriers 10 is preferably made of a curable material that can be formed into the layers 16 of filaments 18 in a liquid or semi-liquid state and then cured or otherwise hardened into a rigid substance. In some embodiments, the curable material may be concrete (e.g., a mixture of cement, aggregates, and water) or concrete mixture. For example, the curable material may be concrete mixed with reinforcing fibers and/or other concrete additives used for controlling the mechanical and/or other properties of the resulting concrete. However, other curable materials, such as cements, mortars, clays, epoxies, curable composite materials, and/or curable polymers could be used to form the matrix 14.

Reinforcing fibers may be used to increase certain mechanical strength properties of the concrete (or other curable material) in lieu of or in addition to other reinforcing systems, such as reinforcing bars (“rebar”) or post tensioning cables. Such reinforcing fibers may include steel or other metal fibers, fiberglass fibers, carbon fibers, various mixtures thereof, and/or other types of reinforcing fibers suitable for use to be mixed into wet concrete to provide numerous small structural reinforcements within the matrix of the cured concrete. In some embodiments, reinforcing fibers are added to the concrete mixture in amounts of about 0.5% to about 1.5% by volume, more preferably about 1%, by volume of the concrete, though lesser and greater amounts could be used.

The barriers 10 may be made by an additive manufacturing process in which the filaments 18 in a first layer 16 (e.g., 16a in FIGS. 5 and 6) are formed by extruding multiple rows of the filaments of the curable material in a liquid or semi-liquid state onto a base, and then extruding the multiple rows of the filaments 18 of the next (second) layer 16 (e.g., 16b in FIGS. 5 and 6) onto the first layer 16a, which now forms the base for the second layer 16b. This process can be repeated as many times as desired and/or necessary to form the overall shape of the body 12 of the barrier 10. The filaments of the second layer 16b are extruded in a different orientation than the filaments of the first layer 16a to obtain the desired pitch angel γ. In the case of a concrete-based matrix 14, the body 12 may be made by a three-dimensional concrete printing (3DCP) type of additive manufacturing process. In the 3DCP process, for example, each filament 18 may be formed by extruding a flow of concrete through an extrusion head onto a surface or previously-extruded layer (e.g., 16a) while moving the extrusion head in a printing direction along the orientation of the filament 18. In this process, the extrusion action also tends to orient any reinforcing fibers within the concrete mix in the direction of the extrusion printing such that the reinforcing fibers are generally axially aligned with the axis of the filament 18. Such alignment is believed to give the resulting body 12 additional anisotropic strength characteristics that may be helpful for absorbing impact energy, such as from an impact from an errant vehicle, while also providing good strength characteristics in one or more directions. In addition to being able to form the complex architectures described above, because 3D concrete printing can strategically place material only where it is needed, it may result in reducing overall material use while maintaining or even improving performance, which can in turn lead to cost savings and/or a lower environmental footprint. In addition, the use of 3DCP allows for the precise customization of barrier shapes and sizes to meet specific site requirements or performance criteria. Such adaptability can provide a significant improvement over a one-size-fits-all approach of many traditional barriers, enabling tailored solutions for different roadway conditions or impact scenarios. 3DCP also allows for the creation of barriers that are not only functional but also aesthetically pleasing, which can be important in urban environments or scenic areas where the visual impact of infrastructure is a concern.

Nonlimiting embodiments of the invention will now be described in reference to experimental investigations leading up to the invention. The intent of the investigations was to use 3D concrete printing techniques with bio-inspired Bouligand and sinusoidal helicoidal architectures to provide energy dissipation, load-bearing capabilities, and damage tolerance due to their helicoidal arrangement and the presence of interfaces, including inter-layer interfaces (between filaments 18 within adjacent layers 16) and inter-filament interfaces (between filaments 18 within an individual layer 16). The interfaces are believed to induce crack twisting and spread of damage to improve impact resistance and energy dissipation capacity. By using these architectures in 3D printed (3DP) concrete roadside barriers, concrete barriers with enhanced energy absorption capacities can be formed, as was discussed above in reference to FIGS. 3 through 6.

In order to design 3D printed concrete with Bouligand and sinusoidal helicoidal architectures and use these designs for transportation infrastructure such as roadside barriers, anisotropic properties were investigated due to the presence of the inter-layer and inter-filament interfaces. The mechanical performances of 3DP concrete samples were evaluated and compared with cast samples under compressive and flexural tests. The samples were tested in different directions to evaluate the anisotropic properties of the 3DP samples due to the presence of the interfaces.

An investigation of anisotropic behavior under flexural test was conducted on samples fabricated with filament orientations of 0 and 90 degrees, along with steel reinforcing fiber volume fractions of 1%, 0.5%, and 0%. The flexural strength of the 0-degree sample with 1% and 0.5% steel fiber was found to be, respectively, 45.4% and 20.2% higher than that of the sample without (i.e., 0%) reinforcing fiber. In contrast, the 90-degree samples showed no notable improvement in flexural strength upon the addition of reinforcing fibers. Moreover, the flexural strength of the 0-degree sample with 1% fiber was 156.2% greater than that of the 90-degree sample with 1% fiber, while the flexural strength of the 0-degree sample without reinforcing fiber was 96.9% higher than that of the 90-degree sample without reinforcing fiber. These findings demonstrated a notable improvement in flexural strength with the addition of reinforcing fibers in the 0-degree sample, while the 90-degree sample exhibited no substantial enhancement, thus highlighting a strong anisotropy present in the 3DP samples. It is believed that this disparity in strength improvement could be attributed to the tendency of the reinforcing fibers to align with the printing direction during the 3D printing process. In the case of the 90-degree samples, the reinforcing fibers tended to align parallel to the loading direction, which, in turn, would allow cracks to propagate through the interfaces, impeding their capacity to enhance flexural strength. In contrast, in the case of the 0-degree samples, the reinforcing fibers tended to align perpendicular to the loading direction and the direction of crack propagation, thereby enhancing the flexural strength. The results suggested that the incorporation of reinforcing fibers has a substantial impact on the anisotropic behavior of 3D-printed samples.

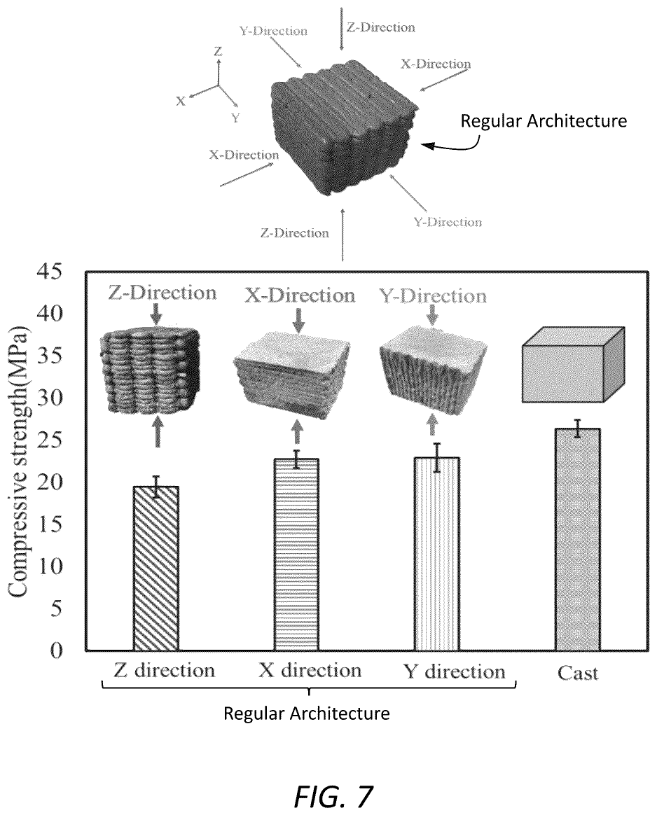

In the tests represented in FIG. 7, each of the 3DP samples has what is described herein as a “regular” architecture, meaning that the 3DP samples are formed by filaments that are neither sinusoidal nor have a helicoidal arrangement. Overall, these regular 3DP samples exhibited a lower compressive strength than the cast concrete samples. Specifically, the average compressive strength of 3DP concrete samples tested in the X, Y, and Z directions was 24.4%, 13.0%, and 25.2% lower than that of the cast concrete samples, respectively. Moreover, the 3D printed concrete samples tested along the X and Y directions exhibited comparable compressive strength, whereas those tested along the Z direction showed approximately a 15% reduction compared to the X and Y directions. It is believed that the 3DP concrete samples exhibited a lower compressive strength than the cast concrete samples due to the presence of interfaces. During the testing, two types of interfaces (inter-layer and inter-filament) were concluded to play significant roles. The properties of the inter-filament interface were typically influenced by the design of the extrusion rate and filament overlap, while the properties of the inter-layer interface were typically affected by the designed layer height and the gravity of the previous printed layers. As shown in FIG. 7, when tested in the X direction, only the interfaces between the layers influenced the compressive behavior, whereas in the Z direction, only the interfaces between the filaments affected the compressive behavior. Testing in the Y direction showed that both interfaces between the layer and the filament influence the compressive behavior. The disparities observed in test results across different directions suggested variations in the mechanical properties of inter-layer and inter-filament interfaces. Taken all together, it was concluded that the 3DP concrete samples exhibited anisotropic behavior in both flexural and compressive tests due to the presence of interfaces. These materials can provide enhanced energy absorption capacity in concrete for transportation infrastructure applications like roadside barriers. Roadside barriers designed with such architected materials have the potential to absorb more energy during impacts, thereby reducing vehicle damage and protecting passengers more effectively.

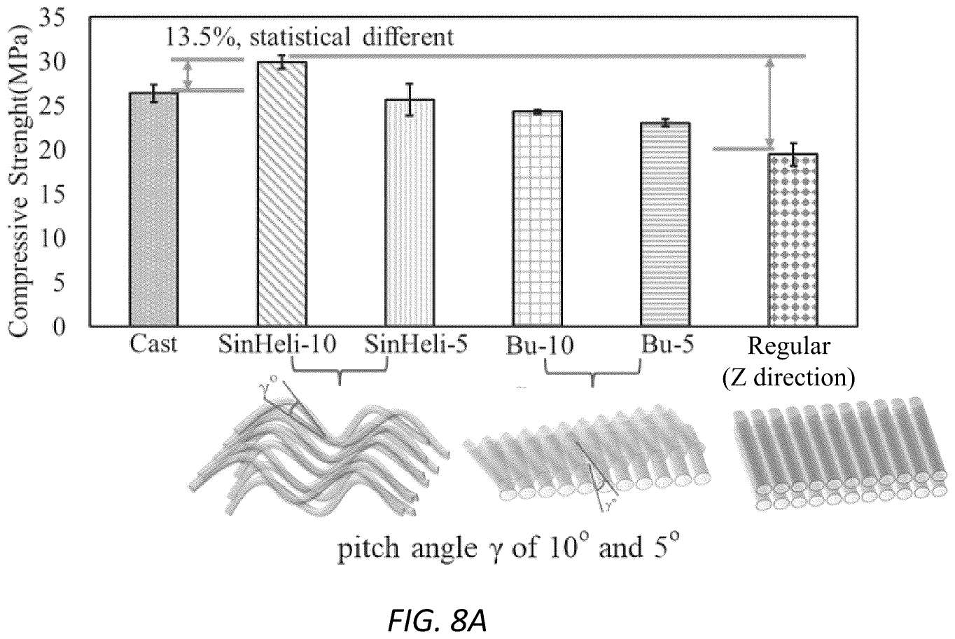

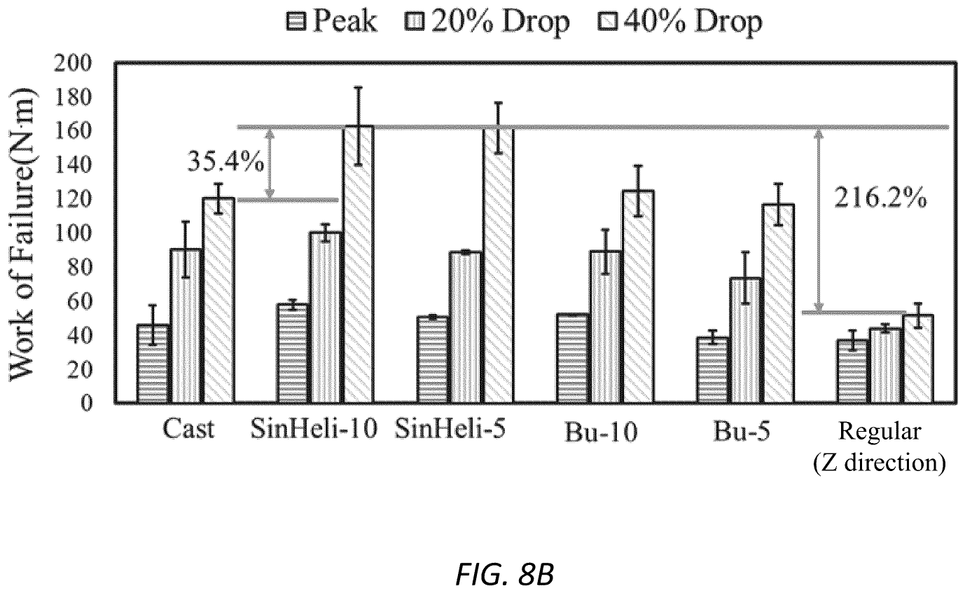

FIGS. 8A and 8B represent results of, respectively, compressive strength and work of failure (WOF) comparisons between cast concrete samples (“Cast”) and 3DP concrete samples having a sinusoidal helicoidal architecture (“SimHeli”), or a Bouligand architecture (“Bu”), or a “Regular” architecture (i.e., formed by filaments that are neither sinusoidal nor have a helicoidal arrangement). The SimHeli samples and the Bu samples had a pitch angle γ of either 10° (“SinHeli-10” and “Bu-10”) or 5° (“SinHeli-5” or “Bu-5”). Work of failure was computed as the area under the load-displacement curve up to a specified level of damage, representing the energy required to cause failure of the sample. In this study, work of failure was estimated by calculating the area under the load-displacement curve after reductions (“drops”) of 0%, 20%, and 40% in the peak load.

Referring to FIG. 8A, the compressive strength of the Bu-10 and Bu-5 samples exceeded that of the regular architecture sample by 22.5% and 18.4%, respectively, but were 8.6% and 14.4% lower, respectively, than that of the cast counterparts. The compressive strengths of the SinHeli-10 and SinHeli-5 samples surpassed that of the regular architecture sample by 53.6% and 31.5%, respectively. When compared to the cast sample, the SinHeli-10 sample exhibited a 13.5% higher compressive strength. The compressive strength of the SinHeli-10 sample was also at least 16.7% higher than that achieved with the Bu-5 and Bu-10 samples. Thus, the sinusoidal helicoidal architecture, particularly the SinHeli-10 sample, exhibited significant enhancements in compressive strength.

Referring to FIG. 8B, the “40% Drop” work of failure of the Bu-10 and Bu-5 samples exhibited levels similar to the cast sample and were 142.3% and 126.8% greater than that of the regular architecture sample. The average 40% Drop work of failure of the SinHeli-10 sample was 35% greater than that of the cast sample, and the “40% Drop” work of failure of the SinHeli-10 and SinHeli-5 samples exhibited increases of 216% and 214% compared to the regular architecture sample. The 40% Drop work of failure of the SinHeli-10 and SinHeli-5 samples were also about 30% higher than that achieved with the Bu-5 and Bu-10 samples. Thus, the sinusoidal helicoidal architecture also exhibited significant enhancements in work of failure.

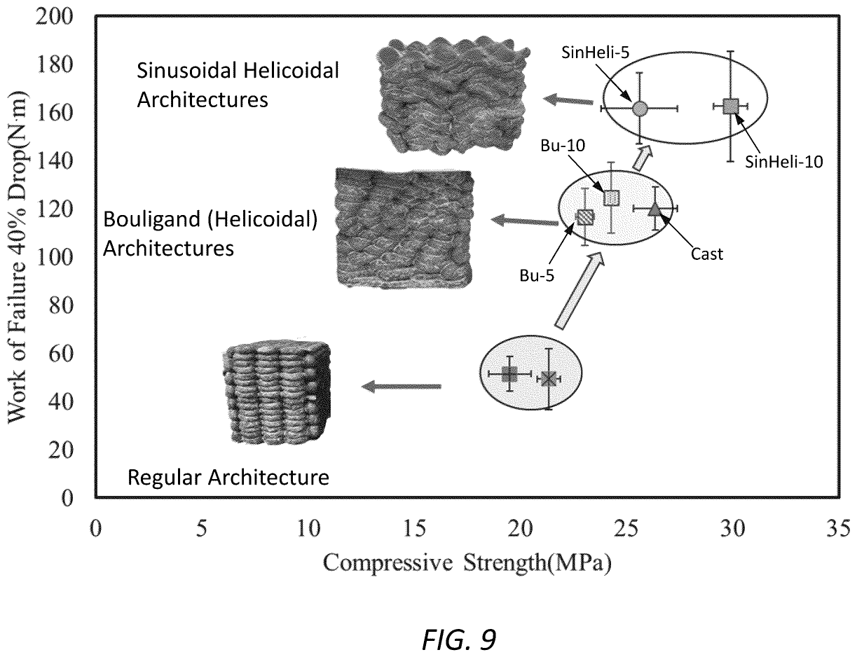

From the Ashby plot of FIG. 9, it can be seen that the cast samples exhibited greater work of failure and compressive strength compared to the regular architecture samples, the Bouligand architecture samples exhibited compressive strength and work of failure similar to the cast samples, and the sinusoidal helicoidal architecture samples demonstrated significant improvements in both compressive strength and work of failure over the cast and Bouligand architecture samples.

The Bouligand and sinusoidal helicoidal architectures were also shown to enhance energy dissipation and influence the mechanical responses in comparison to cast and regular architecture samples. For example, the Bouligand and sinusoidal helicoidal architectures exhibited an ability to utilize twist crack mechanisms along their interfaces, facilitating the spread of damage and enhancing energy dissipation.

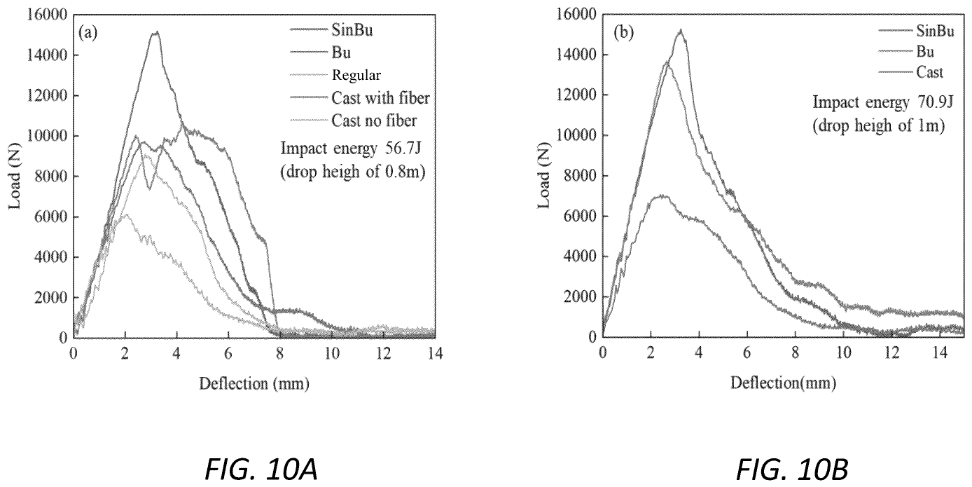

With regard to the data of FIGS. 10A and 10B, the impact loads were obtained utilizing a drop tower impact test setup, the cast samples included samples with and without fiber reinforcement, and the 3DP samples included Bouligand, sinusoidal helicoidal, and regular architectures. Impact energies were 56.7 J (drop height of 0.8 m) and 70.9 J (drop height of 1 m). The load-deflection curves of FIGS. 10A and 10B highlight the differing abilities of the different architecture and cast samples to respond to dynamic impact loads and absorb energy. Higher peak loads and delayed decline in the curves for the sinusoidal helicoidal and Bouligand samples indicated their enhanced impact resistance at both energy levels.

At a drop height of 0.8 m (FIG. 10A), the sinusoidal helicoidal sample achieved the highest peak load (14,666.4N) and absorbed 56.6 J of energy, while the Bouligand sample achieved a peak load of 9,968.5N, absorbing 53.6 J of energy. The sinusoidal helicoidal sample demonstrated the highest peak load of all samples and exhibited similar energy absorption to the Bouligand sample. The sinusoidal helicoidal sample had a peak load of 49.12% higher than the Bouligand sample, 52.4% higher than the regular architecture samples, and 34.8% higher than the cast samples with fiber, while its absorbed impact energy increased by 20.8% and 29.7%, respectively. Compared to the cast sample without fiber, the sinusoidal helicoidal sample showed a 98.8% increase in peak load and a 102.6% increase in absorbed impact energy.

As shown in FIG. 10B, at an impact energy of 70.9 J (from a drop height of 1 m), the sinusoidal helicoidal sample exhibited a peak load of 14,133.8N and absorbed 66.3 J of energy, while the Bouligand sample exhibited a peak load of 12,192.5N, absorbing 68.7 J of energy. The sinusoidal helicoidal sample had a peak load of 15.9% higher than the Bouligand sample. The cast sample with fibers exhibited a peak load of 8,383.8N and absorbed 44.5 J of impact energy. The sinusoidal helicoidal and Bouligand samples surpassed the peak load of the cast sample by 68.6% and 45.4%, respectively, and exceeded its absorbed impact energy by 49.2% and 54.6%, respectively. Compared to the results at the drop height of 0.8 m, the energy absorbed by the sinusoidal helicoidal and Bouligand samples increased, while the energy absorbed by the cast sample remained similar due to fatal damage it sustained.

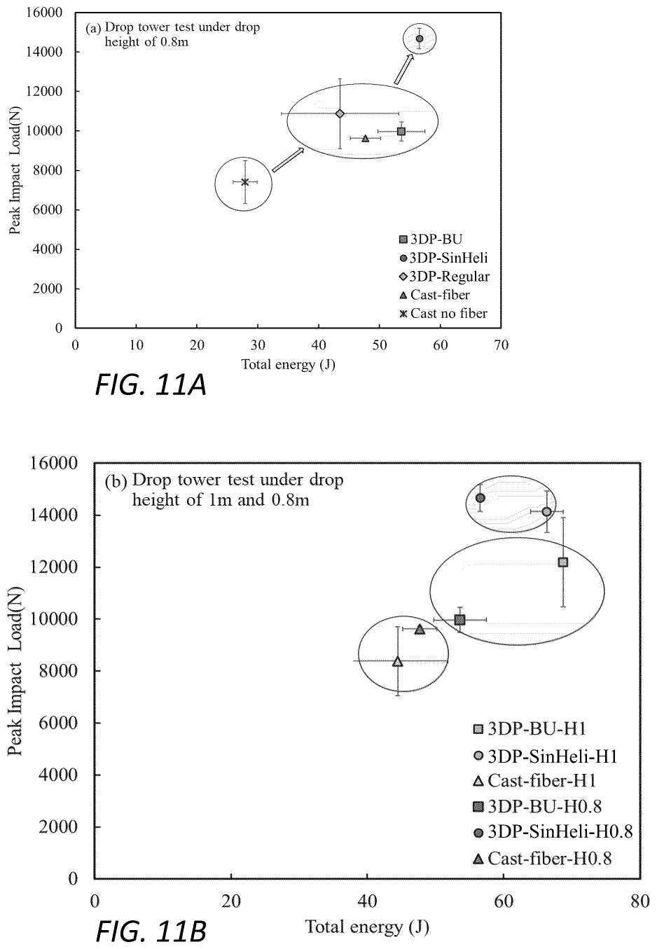

FIG. 11A contains fracture pattern images and an Ashby plot of the average peak impact load and absorbed energy for different samples under an impact energy of 56.7 J (drop height of 0.8 m). The sinusoidal helicoidal sample exhibited the highest peak load and absorbed energy compared to the other samples. The Bouligand sample exhibited a slightly lower peak load but similar absorbed energy as compared to the sinusoidal helicoidal sample. Both the sinusoidal helicoidal and Bouligand samples outperformed the cast samples. As seen in the fracture pattern images, the sinusoidal helicoidal and Bouligand architectures demonstrated excellent resistance to crack propagation and maintained their structural integrity. In contrast, the cast samples (with and without fiber) and the regular architecture samples suffered significant structural damage, failed to absorb the full impact energy, and exhibited severe failure. These results underscored the superior impact resistance of the sinusoidal helicoidal and Bouligand architectures.

FIG. 11B contains fracture pattern images and an Ashby plot that illustrates the average peak impact load and absorbed energy for different samples under two impact energy levels: 56.7 J (“H0.8”) and 70.9 J (“H1”). Both the sinusoidal helicoidal and Bouligand architecture samples exhibited increased energy absorption as the imposed energy increased. These architectures were more effective under impact loading conditions compared to the cast samples, owing to their ability to prevent fatal crack development and maintain structural integrity. In contrast, the cast samples failed to absorb higher impact energy due to the extensive damage they sustained under both conditions.

These investigations highlighted the role of filament orientation and fiber incorporation in enhancing flexural and compressive strength. The findings demonstrated that Bouligand (helicoidal) architectures and sinusoidal helicoidal architectures can achieve superior mechanical performance compared to traditional cast concrete barriers, making them ideal for use in high-impact scenarios. 3D concrete printing combined with Bouligand and sinusoidal helicoidal architectures may provide a cost-effective, lightweight, and energy-efficient solution for roadside safety.

Integrating Bouligand and sinusoidal helicoidal architectures with 3D concrete printing enhanced the energy absorption capacity of concrete barriers. The use of the Bouligand and sinusoidal helicoidal architectures provided improved dissipation of impact energy through mechanisms like crack twisting and controlled damage propagation. This results in roadside barriers that are not only strong enough to withstand high-impact loads but also flexible enough to reduce the severity of impacts on vehicles, thereby improving overall roadside safety.

In addition to the roadside barriers described with respect to the drawings, additional applications and/or uses of the energy absorbing concretes described herein are also possible.

As nonlimiting examples, the energy-absorbing concretes may be used for impact-resistant features in nuclear transport and storage containers, for example, to improve drop and puncture resistance while preserving shielding and thermal performance. To accomplish this, outer sacrificial shells or integrated liners may be printed using the additive manufacturing techniques that use helicoidal and Bouligand inspired paths as described herein to twist and deflect cracks, delay spalling, and/or spread impact loads. Steel and/or carbon fibers may be embedded in the concrete to create a conductive network for electromagnetic attenuation and/or tune particle packing to reduce permeability. The energy-absorbing concrete may be combined with metal internals if desired. Such containers made with the energy-absorbing concrete can be built to meet existing transport standards that include drop and puncture tests plus thermal excursions. The bio inspired shell made of the energy-absorbing concrete can function as an energy absorber and as a damage tolerance layer that protects the inner containment boundary.

In further nonlimiting examples, the energy-absorbing concrete may be used for impact-resistant building elements in protective shelters for personnel and assets, such as windstorm and natural hazard shelters intended to withstand tornado and/or hurricane debris impact, extreme uplift and suction, and/or floodborne debris. The use of the 3D-printed energy-absorbing concrete may also keep weight and logistical challenges low. for example. In this implementation, various building elements, such as walls, roofs, and/or other architectural and/or structural elements, may be 3D printed to have one or both of the energy-absorbing concrete matrices disclosed herein may be formed. For example, walls and roofs may be 3D printed to include complex morphology, such as ribbed and vault-like shells, that route forces along preselected paths and/or use internal sacrificial webs that crush and delaminate in a stable manner. Fiber networks may be integrated into the energy-absorbing concrete for post crack bridging and use graded infill to tailor local stiffness. Other targeted admixtures and fiber additions could be incorporated. Advantages of such construction may include shelters that fail gracefully, retain their integrity, and/or can be printed with local materials. Moisture resistant concrete mixes, fiber networks for post crack bridging, graded infill to tune local stiffness, and/or anchorage and ballast features for buried or partially buried modules to control uplift and buoyancy may be used. In addition, 3D printing concrete building elements may shorten construction schedules, reduce formwork and/or rebar, and/or make it possible to adapt the geometry of a given structure to the unique circumstances of any given site geometry. If desired the building elements may be manufactured off-site, for example by 3D-printing the energy-absorbing concrete into almost any desired shape and size of a building element in a pre-cast concrete manufacturing plant. Such building elements may be delivered to the construction site, for example, with process windows and print paths that align with the target printer.

In still further nonlimiting examples, the energy-absorbing concrete may be used for impact-resistant building elements in bridges, buildings, and/or other general infrastructure structures that would benefit from having energy-absorbing impact resistance. The use of the energy-absorbing concrete to form such structures may increase tolerance to vehicle, vessel, and/or rock impacts and/or improve service life under fatigue and harsh environments. For example, pier jackets, parapets, and/or façade panels may be 3D-printed as described herein to form the energy-absorbing concrete structures with energy absorbing concrete cores that twist cracks and limit scabbing. For buildings, architected panels at known strike zones, such as loading docks and perimeter walls, could be made of the energy absorbing concrete.

In another nonlimiting example, the energy-absorbing concrete may be used for impact-resistant building elements in tunnel linings and tunnel portals to extend service life and/or reduce maintenance in abrasive and impact prone environments. For example, segments may be 3D printed concrete with helicoidal and/or sinusoidal internal paths as disclosed herein that redistribute and/or absorb impact energy from local hits from rock fall, ballast ejection, and/or equipment strikes.

Additional applications of the 3D-printed energy-absorbing concrete disclosed herein include, by way of nonlimiting examples, using such concrete and manufacturing techniques to build substation and transformer perimeter walls, bridge pier fenders and navigation protection for waterways, protective vaults for critical data center equipment and fuel tanks, and rockfall and avalanche galleries for mountain roads and rail corridors. The 3D-printed energy-absorbing concrete disclosed herein may also be used to build various impact-risk marine and underwater structures that would benefit from the energy-absorbent characteristics thereof, such as bridge pier jackets and collars; scour protection shells and armoring elements; offshore wind turbine splash zone sleeves and caisson repairs; harbor and quay wall fender modules, subsea cable crossings and protective saddles; pipeline supports, clamps, and saddle blocks; lock and dam gate bumpers and sill repair elements; artificial reef and habitat units; mooring anchors, pads, and ballast modules; and underwater sensor housings and instrument vaults.

As previously noted above, though the foregoing detailed description describes certain aspects of one or more particular embodiments of the invention, alternatives could be adopted by one skilled in the art. For example, the roadside barriers and their components could differ in appearance and construction from the embodiments described herein and shown in the drawings, functions of certain components of the roadside barriers could be performed by components of different construction but capable of a similar (though not necessarily equivalent) function, and various materials could be used in the fabrication of the roadside barriers and/or their components. As such, and again as was previously noted, it should be understood that the invention is not necessarily limited to any particular embodiment described herein or illustrated in the drawings.

1. An energy-absorbing structure comprising:
a body comprising a laminar matrix having a plurality of layers, each layer of the plurality of layers comprising a plurality of filaments, the plurality of filaments of each layer being oriented so that axes of individual filaments within each layer are substantially parallel to each other and the plurality of filaments in a first layer of the plurality of layers are oriented in a different direction than the plurality of filaments in a second layer of the plurality of layers that is adjacent to the first layer.

2. The energy-absorbing structure of claim 1, wherein the plurality of layers and the plurality of filaments form at least one of a Bouligand architecture and a sinusoidal helicoidal architecture.

3. The energy-absorbing structure of claim 1, wherein the plurality of layers and the plurality of filaments form a sinusoidal helicoidal architecture.

4. The energy-absorbing structure of claim 1, wherein the laminar matrix is formed of a curable material.

5. The energy-absorbing structure of claim 4, wherein the curable material comprises concrete.

6. The energy-absorbing structure of claim 4, wherein the laminar matrix comprises reinforcing fibers incorporated into the curable material.

7. The energy-absorbing structure of claim 6, wherein the structure comprises a roadside barrier.

8. The energy-absorbing structure of claim 6, wherein the laminar matrix contains about 1.5% volume to about 0.5% volume of the reinforcing fibers.

9. The energy-absorbing structure of claim 6, wherein the reinforcing fibers are aligned with the orientation of the axis of the filament in which they are disposed.

10. The energy-absorbing structure of claim 1, wherein the structure comprises at least one of a nuclear storage container, an impact-resistant building element, substation perimeter wall, transformer perimeter wall, bridge pier fender, navigation protection structure for a waterway, protective vault for data center equipment, protective vault for a fuel tank, rockfall gallery, avalanche gallery, and impact-risk marine structure.

11. A method of fabricating an energy-absorbing structure, the method comprising:
forming the structure by additive manufacturing of a curable material when in a liquefied state to form a body comprising a laminar matrix having a plurality of layers, each layer of the plurality of layers comprising a plurality of filaments, the plurality of filaments of each layer being oriented so that axes of individual filaments within each layer are substantially parallel to each other and the plurality of filaments in a first layer of the plurality of layers are oriented in a different direction than the plurality of filaments in a second layer of the plurality of layers that is adjacent to the first layer; and
curing the curable material into a hardened material.

12. The method of claim 11, wherein the curable material comprises concrete.

13. The method of claim 11, wherein the plurality of layers and the plurality of filaments form at least one of a Bouligand architecture and a sinusoidal helicoidal architecture.

14. The method of claim 11, wherein the plurality of layers and the plurality of filaments form a sinusoidal helicoidal architecture.

15. The method of claim 11, wherein the additive manufacturing comprises three-dimensional concrete printing.

16. The method of claim 15, wherein the three-dimensional concrete printing comprises forming each filament of the plurality of filaments by extruding concrete through an extrusion head while moving the extrusion head in a printing direction along the orientation of the filament.

17. The method of claim 16, wherein the concrete comprises reinforcement fibers and the reinforcement fibers align with the printing direction.

18. The method of claim 17, wherein the laminar matrix contains about 1.5% volume to about 0.5% volume of the reinforcing fibers.

19. The method of claim 11, wherein the energy-absorbing structure comprises a roadside barrier.

20. The method of claim 11, wherein the energy-absorbing structure comprises a nuclear storage container, impact-resistant building element, substation perimeter wall, transformer perimeter wall, bridge pier fender, navigation protection structure for a waterway, protective vault, rockfall gallery, avalanche gallery, or an impact-risk marine structure.
